(19) United States
(12) Patent Application Publication
(10) Pub. No.: US 2013/0266868 A1
(43) Pub. Date: Oct. 10, 2013

(54) METHOD OF PREPARING POSITIVE ACTIVE MATERIAL FOR RECHARGEABLE LITHIUM BATTERY, POSITIVE ACTIVE MATERIAL FOR RECHARGEABLE LITHIUM BATTERY PREPARED BY USING THE METHOD, AND RECHARGEABLE LITHIUM BATTERY INCLUDING THE SAME

(71) Applicants: Yang-Kook Sun, Seoul (KR); Hyo-Jin Kim, Gyeongsangbuk-do (KR)

(72) Inventors: Yang-Kook Sun, Seoul (KR); Hyo-Jin Kim, Gyeongsangbuk-do (KR)

(21) Appl. No.: 13/822,892

(22) PCT Filed: Sep. 14, 2011
(86) PCT No.: PCT/KR11/06779

§ 371 Date: Jun. 7, 2013

(30) Foreign Application Priority Data
Sep. 14, 2010 (KR) 10-2010-0090051

(51) Int. Cl. H01M 4/525

(52) U.S. Cl. CPC H01M 4/525
USPC 429/223; 252/182.1

(57) ABSTRACT

Provided are a method of preparing a positive active material for a rechargeable lithium battery that includes: forming a positive active material for a rechargeable lithium battery precursor by mixing at least one of a nickel source, a cobalt source, and a manganese source with a carbon source and a solvent; and mixing the active material precursor for a rechargeable lithium battery and a lithium source followed by heat treatment, a positive active material for a rechargeable lithium battery prepared in the method, and a rechargeable lithium battery including the same.

### BACKGROUND

1. Field

This disclosure relates to a method of preparing a positive active material for a rechargeable lithium battery, a positive active material for a rechargeable lithium battery prepared according to the method, and a rechargeable lithium battery including the same.

2. Description of the Related Art

Batteries generate electric power by using materials capable of having an electrochemical reaction at positive and negative electrodes. For example, a rechargeable lithium battery generates electricity due to a change of chemical potentials, when lithium ions are intercalated/deintercalated at positive and negative electrodes.

The rechargeable lithium battery includes a material that can reversibly intercalate/deintercalate lithium ions at positive and negative active materials, as well as an organic electrolyte solution or a polymer electrolyte charged between the positive and negative electrodes.

As for the negative active material for the lithium rechargeable battery, various carbon-based materials such as artificial graphite, natural graphite, and hard carbon that are capable of intercalating and deintercalating lithium ions have been used.

As for the positive active material for the lithium rechargeable battery, a lithium metal composite compound is used. For example, a metal composite oxide such as LiCoO₂, LiMn₂O₄, LiNiO₂, LiNi₁₋ₓCoₓO₂ (0<x<1), LiMnO₂, LiFePO₄, and the like has been researched.

### SUMMARY

One embodiment provides a method of preparing a positive active material for a rechargeable lithium battery by using a carbon source during the preparation of the positive active material in order to control the size of primary particles in the positive active material and form pores therein.

Another embodiment provides a positive active material for a rechargeable lithium battery prepared according to the method of preparing a positive active material for a rechargeable lithium battery.

Yet another embodiment provides a rechargeable lithium battery including the positive active material for a rechargeable lithium battery.

### Technical Solution

According to one embodiment, a method of preparing a positive active material for a rechargeable lithium battery includes forming a positive active material precursor for a rechargeable lithium battery by mixing at least one of a nickel source, a cobalt source, and a manganese source with a carbon source and a solvent; and mixing the active material precursor for a rechargeable lithium battery and a lithium source followed by heat treatment.

The nickel source may include nickel sulfate, nitric acid nickel, nickel acetate, nickel chloride, nickel phosphate, or a combination thereof.

The cobalt source may include cobalt sulfate, cobalt nitrate, cobalt acetate, cobalt chloride, cobalt phosphate, or a combination thereof.

The manganese source may include manganese sulfate, manganese nitrate, manganese acetate, manganese chloride, manganese phosphate, or a combination thereof.

The carbon source may include sucrose, glucose, polyvinyl alcohol (PVA), polyvinyl pyrrolidone (PVP), colloidal carbon, citric acid, tartaric acid, glycolic acid, polyacrylic acid, adipic acid, glycine, or a combination thereof.

The solvent may include water, ethanol, methanol, or a combination thereof.

In the step of forming the positive active material precursor for a rechargeable lithium battery, the nickel source may be mixed in an amount of about 0 wt % to about 75 wt %, the cobalt source may be mixed in an amount of about 0 wt % to about 40 wt %, the manganese source may be mixed in an amount of about 0 wt % to about 95 wt %, the carbon source may be mixed in an amount of about 2 wt % to about 40 wt %, and the solvent may be mixed in an balance amount.

In addition, the carbon source may be mixed in an amount of 5 parts by weight to 30 parts by weight based on 100 parts by weight of the total weight of the nickel source, the cobalt source, and the manganese source.

In the step of forming the positive active material precursor, a transition element source may be further mixed, and the transition element source may include a sulfate of a transition element, a nitrate of a transition element, an acetate of a transition element, a chloride of a transition element, a phosphate of a transition element, or a combination thereof.

The lithium source may include lithium nitrate (LiNO₃), lithium acetate (CH₃COOLi), lithium carbonate (Li₂CO₃), lithium hydroxide (LiOH), or a combination thereof.

The active material precursor for a rechargeable lithium battery and the lithium source may be mixed in a mole ratio of about 1.0:0.95 to about 1.0:1.25. Herein, the prepared positive active material for a rechargeable lithium battery may include a compound having a layered structure and represented by the following Chemical Formula 1.

Li₁₊ₓ[NaₐCo_{b}M_{c}Mn_{d}]₁₋ₓO_{2-y}F_{y} [Chemical Formula 1]

In the above Chemical Formula 1,

M is a transition element,

−0.05≦x≦0.25,

0≦y≦0.05,

0.2≦a≦0.9, 0≦b≦0.5, 0≦c≦0.05, 0.1≦d≦0.9, and a+b+c+d=1.

For example, the M may include Ti, V, Cr, Fe, Cu, Zn, Y, Zr, Nb, Mo, W, or a combination thereof.

The active material precursor for a rechargeable lithium battery and the lithium source may be mixed in a mole ratio of about 1.0:0.4 to about 1.0:0.6. Herein, the prepared positive active material for a rechargeable lithium battery may include a compound having a spinel structure and represented by the following Chemical Formula 2.

Li₁₊ₓ[NiₐCo_{b}M_{c}Mn_{d}]₂₋ₓO_{4-y}F_{y} [Chemical Formula 2]

In the above Chemical Formula 2,

M is a transition element,

0≦x≦0.1,

0≦y≦0.2,

0≦a≦0.3, 0≦b≦0.2, 0≦c≦0.15, 0≦d≦1.0, and a+b+c+d=1.

Examples of the M are the same as described above.

The heat treatment may be performed through primary firing at a temperature of about 250° C. to about 650° C. and secondary firing at a temperature of about 700° C. to about 1000° C.

According to another embodiment, a positive active material for a rechargeable lithium battery prepared according to the method of preparing a positive active material for a rechargeable lithium battery is provided.

The positive active material for a rechargeable lithium battery may include secondary particles formed by agglomerating a plurality of primary particles.

The positive active material for a rechargeable lithium battery may include a compound having a layered structure and represented by the above Chemical Formula 1. Herein, the compound having a layered structure and represented by the above Chemical Formula 1 may include primary particles having an average particle diameter of about 1 nm to about 500 nm. In addition, the positive active material including the compound having a layered structure and represented by the above Chemical Formula 1 may have tap density of about 1.5 g/cc to about 3.0 g/cc and a specific surface area of about 1.0 m²/g to about 10.0 m²/g, and may include pores having an average diameter of about 1 nm to about 50 nm.

The positive active material for a rechargeable lithium battery may include a compound having a spinel structure and represented by the above Chemical Formula 2. Herein, the positive active material including the compound having a spinel structure and represented by the above Chemical Formula 2 may include primary particles having an average particle diameter of about 1 nm to about 1000 nm. In addition, the positive active material including the compound having a spinel structure and represented by the above Chemical Formula 2 may have tap density of about 1.5 g/cc to about 3.0 g/cc and a specific surface area of about 1.0 m²/g to about 10.0 m²/g, and may include pores having an average diameter of about 1 nm to about 50 nm.

According to yet another embodiment, a rechargeable lithium battery is that includes a positive electrode including the positive active material, a negative electrode including a negative active material, and an electrolyte is provided.

Other embodiments are described in the following detailed description.

According to the embodiment, the method of preparing a positive active material for a rechargeable lithium battery uses a carbon source during formation of a positive active material precursor in order to control primary particle size of the positive active material and form pores therein. The positive active material for a rechargeable lithium battery prepared according to the method may have high tap density and improve cycle-life and output characteristics of a rechargeable lithium battery.

### BRIEF DESCRIPTION OF THE DRAWINGS

FIG. 1 is a schematic view showing a rechargeable lithium battery according to one embodiment.

FIG. 2 is a SEM photograph showing a positive active material for a rechargeable lithium battery according to Example 1.

FIG. 3 is a SEM photograph showing a positive active material for a rechargeable lithium battery according to Comparative Example 1.

FIG. 4 is a SEM photograph showing a positive active material for a rechargeable lithium battery according to Example 2.

FIG. 5 is a SEM photograph showing a positive active material for a rechargeable lithium battery according to Comparative Example 2.

FIG. 6 is a graph showing cycle-life characteristics of rechargeable lithium battery cells according to Example 3 and Comparative Example 3.

FIG. 7 is a graph showing cycle-life characteristics of rechargeable lithium battery cells according to Example 4 and Comparative Example 4.

### DETAILED DESCRIPTION

The present invention will be described more fully hereinafter with reference to the accompanying drawings, in which exemplary embodiments of this disclosure are shown. However, these embodiments are exemplary, and the present invention is not limited thereto and is defined by the claims described later.

In the drawings, the thickness of layers, films, panels, regions, etc., are exaggerated for clarity. Like reference numerals designate like elements throughout the specification.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

According to one embodiment, a method of preparing a positive active material for a rechargeable lithium battery includes: forming a positive active material precursor for a rechargeable lithium battery by mixing at least one of a nickel source, a cobalt source, and a manganese source with a carbon source and a solvent; and mixing the active material precursor and a lithium source followed by heat treatment.

Since the positive active material precursor for a rechargeable lithium battery is formed by using the carbon source, carbon is evenly included inside the positive active material precursor and dispelled into the air during the drying. Accordingly, where the carbon existed in the positive active material precursor, a pore is formed. This positive active material precursor is used to adjust the primary particle size of a positive active material and to form pores in the positive active material, controlling morphology thereof. Accordingly, the positive active material may have high tap density, and thus a rechargeable lithium battery including the positive active material may have excellent cycle-life and output characteristics.

The nickel source may include nickel sulfate, nickel nitrate, nickel acetate, nickel chloride, nickel phosphate, or a combination thereof, but is not limited thereto.

The cobalt source may include cobalt sulfate, cobalt nitrate, cobalt acetate, cobalt chloride, cobalt phosphate, or a combination thereof, but is not limited thereto.

The manganese source may include manganese sulfate, manganese nitrate, manganese acetate, manganese chloride, manganese phosphate, or a combination thereof, but is not limited thereto.

The carbon source may include sucrose, glucose, polyvinyl alcohol (PVA), polyvinyl pyrrolidone (PVP), colloidal carbon, citric acid, tartaric acid, glycolic acid, polyacrylic acid, adipic acid, glycine, or a combination thereof, but is not limited thereto.

The solvent may include water, ethanol, methanol, or a combination thereof, but is not limited thereto.

The positive active material precursor for a rechargeable lithium battery may be formed by mixing the nickel source in an amount of about 0 wt % to about 75 wt %, the cobalt source in an amount of about 0 wt % to about 40 wt %, the manganese source in an amount of about 0 wt % to about 95 wt %, the carbon source in an amount of about 2 wt % to about 40 wt %, and the solvent in a balance amount. In addition, the carbon source may be included in an amount of about 5 to about 30 parts by weight based on 100 parts by weight of the total weight of the nickel source, the cobalt source, and the manganese source. When each component is mixed within the range, the positive active material precursor for a rechargeable lithium battery may be effectively formed. Specifically, the positive active material precursor for a rechargeable lithium battery may be formed by mixing the nickel source in an amount of about 0 wt % to about 50 wt %, the cobalt source in an amount of about 0 wt % to about 20 wt %, the manganese source in an amount of about 0 wt % to about 90 wt %, the carbon source in an amount of about 5 wt % to about 20 wt %, and the solvent in a balance amount.

More specifically, when the positive active material for a rechargeable lithium battery has a layered structure, the positive active material may be formed by mixing the nickel source in an amount of about 20 wt % to about 70 wt %, the cobalt source in an amount of about 5 wt % to about 20 wt %, the manganese source in an amount of about 20 wt % to about 70 wt %, the carbon source in an amount of about 5 wt % to about 20 wt %, and the solvent in a balance amount.

Much more specifically, when the positive active material for a rechargeable lithium battery has a spinel structure, the positive active material precursor may be formed by mixing the nickel source in an amount of about 0 wt % to about 30 wt %, the cobalt source in an amount of about 0 wt % to about 20 wt %, the manganese source in an amount of about 60 wt % to about 95 wt %, the carbon source in an amount of about 5 wt % to about 20 wt %, and the solvent in a balance amount.

The positive active material precursor for a rechargeable lithium battery may be formed by further including a transition element source. The transition element source may include a sulfate, nitrate, acetate, chloride, or phosphate of a transition element, or a combination thereof, but is not limited thereto.

The formation of the positive active material precursor may be performed under an inactive atmosphere, an oxidizing atmosphere, and the like, but is not limited thereto.

The lithium source may include lithium nitrate (LiNO₃), lithium acetate (CH₃COOLi), lithium carbonate (Li₂CO₃), lithium hydroxide (LiOH), or a combination thereof, but is not limited thereto.

The active material precursor and the lithium source may be mixed in a mole ratio of about 1.0:0.95 to about 1.0:1.25. When the active material precursor and the lithium source are mixed within the mole ratio range, a positive active material having a layered structure including a compound represented by the following Chemical Formula 1 may be effectively formed. In addition, the positive active material having a layered structure has excellent thermal stability and may effectively improve reliability of a battery, even when the charge depth increases by heightening the charge voltage of the battery. Specifically, the active material precursor and the lithium source may be mixed in a mole ratio of about 1.0:1.02 to about 1.0:1.2.

Li₁₊ₓ[NiₐCo_{b}M_{c}Mn_{d}]₁₋ₓO_{2-y}F_{y} [Chemical Formula 1]

In the above Chemical Formula 1,

M is a transition element,

−0.05≦x≦0.25,

0≦y≦0.05,

0.2≦a≦0.09, 0≦b≦0.5, 0≦c≦0.05, 0.1≦d≦0.9, and a+b+c+d=1.

Specifically, in the above Chemical Formula 1, 0.15≦x≦0.2, 0≦y≦0.01, 0.2≦a≦0.3, 0≦b≦0.2, 0≦c≦0.01, 0.6≦d≦0.8, and a+b+c+d=1.

Specifically, the M may be Ti, V, Cr, Fe, Cu, Zn, Y, Zr, Nb, Mo, W, or a combination thereof.

On the other hand, the active material precursor for a rechargeable lithium battery and the lithium source may be mixed in a mole ratio of about 1.0:0.4 to about 1.0:0.6. When the active material precursor and lithium source are mixed within the mole ratio range, the positive active material having a spinel structure and including a compound represented by the following Chemical Formula 2 may be effectively prepared. In addition, the positive active material having a spinel structure may be economically excellent and stable, and thus commercially available. Specifically, the active material precursor and the lithium source may be mixed in a mole ratio of about 1.0:0.48 to about 1.0:0.52.

Li₁₊ₓ[NiₐCo_{b}M_{c}Mn_{d}]₂₋ₓO_{4-y}F_{y} [Chemical Formula 2]

In the above Chemical Formula 2,

M is a transition element,

0≦x≦0.1,

0≦y≦0.2,

0≦a≦0.3, 0≦b≦0.2, 0≦c≦0.15, 0≦d≦1.0, and a+b+c+d=1.

Specifically, in the above Chemical Formula 2, 0≦x≦0.02, 0≦y≦0.05, 0≦a≦0.2, 0≦b≦0.05, 0≦c≦0.05, 0.6≦d≦1.0, and a+b+c+d=1.

The M is the same as aforementioned.

The heat treatment may be performed through primary firing at about 250° C. to about 650° C. and secondary firing at about 700° C. to about 1000° C. When the heat treatment is performed within the range, moisture and impurities of precipitates may be effectively removed, improving purity of the positive active material. In addition, the heat treatment may effectively control growth of the positive active material particles and secure excellent electrochemical characteristics. Specifically, the heat treatment may be performed through primary firing at about 280° C. to about 630° C. and secondary firing at about 750° C. to about 850° C.

The heat treatment may be performed at a rate of about 1° C./min to about 10° C./min. When the temperature is increased within the range, moisture included in the mixture may be effectively removed. In addition, the heat treatment may effectively control a crystal structure of the mixture and the positive active material formed form the mixture. Specifically, the heat treatment may be performed at a rate of about 2° C./min to about 5° C./min.

The primary firing may be performed for about 5 hours to about 20 hours, and specifically, about 10 hours to about 30 hours. When the primary firing is performed within the time range, moisture and impurities may be effectively removed. In addition, the heat treatment may effectively control the crystal structure of the mixture and the positive active material formed of the mixture. Specifically, the primary firing may be performed for about 5 hours to about 10 hours, and more specifically, for about 10 hours to about 20 hours.

In the method of preparing a positive active material for a rechargeable lithium battery, a complexing agent such as an ammonia aqueous solution, a pH controlling agent such as an alkali aqueous solution providing a hydroxide group, a heat treatment atmosphere, and the like that are well-known in the related art may not be illustrated.

The method may provide a positive active material for a rechargeable lithium battery according to one embodiment.

According to another embodiment, a positive active material for a rechargeable lithium battery prepared according to the method is provided.

The positive active material for a rechargeable lithium battery may include secondary particles formed by agglomerating a plurality of primary particles.

The positive active material may be controlled regarding primary particle size and have pores, a high tap density, and a large specific surface area, and thus has improved output and cycle-life characteristics of a rechargeable lithium battery.

The positive active material may include a compound having a layered structure and represented by the above Chemical Formula 1.

The compound having a layered structure and represented by the above Chemical Formula 1 may include primary particles having an average particle diameter of about 1 nm to about 500 nm. When the primary particles have an average particle diameter within the range, agglomeration of the primary particles may not only be effectively controlled, but a side reaction of the positive active material with an electrolyte solution may also be decreased. Accordingly, the primary particles may effectively improve electrochemical characteristic of the positive active material. Specifically, the primary particles may have an average particle diameter of about 2 nm to about 200 nm.

The positive active material including a compound having a layered structure and represented by the above Chemical Formula 1 has tap density of about 1.5 g/cc to about 3.0 g/cc. When the positive active material including a compound having a layered structure and represented by the above Chemical Formula 1 has tap density within the range, more positive active material per unit volume may be included, thus increasing capacity per unit volume and thus entire energy density. Specifically, the positive active material including a compound having a layered structure and represented by the above Chemical Formula 1 may have tap density ranging from about 1.9 g/cc to about 2.5 g/cc.

The positive active material including a compound having a layered structure and represented by the above Chemical Formula 1 may have a specific surface area ranging from about 1.0 m²/g to about 10.0 m²/g. When the positive active material including a compound having a layered structure and represented by the above Chemical Formula 1 has a specific surface area within the range, a side reaction with an electrolyte solution may be decreased. Specifically, the positive active material including a compound having a layered structure and represented by the above Chemical Formula 1 may have a specific surface area ranging from about 2.0 m²/g to about 5.0 m²/g.

The positive active material including a compound having a layered structure and represented by the above Chemical Formula 1 may have pores. The pores may have an average diameter ranging from about 1 nm to about 50 nm. When the positive active material including a compound having a layered structure and represented by the above Chemical Formula 1 has pores having an average diameter within the range, the positive active material has a larger reaction area with an electrolyte solution, and thus easily intercalates and deintercalates lithium ions. Specifically, the pores included in the positive active material including a compound having a layered structure and represented by the above Chemical Formula 1 may have an average diameter of about 5 nm to about 20 nm.

On the other hand, the positive active material for a rechargeable lithium battery may include a compound having a spinel structure and represented by the above Chemical Formula 2.

The positive active material including a compound having a spinel structure and represented by the above Chemical Formula 2 may include primary particles having an average particle diameter of about 1 nm to about 1000 nm. When the primary particles have an average particle diameter within the range, the primary particles may be effectively controlled from agglomeration and the side reaction of the positive active material with an electrolyte solution may be decreased, thus effectively improving electrochemical characteristics of the positive active material for a rechargeable lithium battery. Specifically, the primary particles may have an average particle diameter of about 2 nm to about 350 nm.

The positive active material including a compound having a spinel structure and represented by the above Chemical Formula 2 may have tap density of about 1.5 g/cc to about 3.0 g/cc. When the positive active material including a compound having a spinel structure and represented by the above Chemical Formula 2 has tap density within the range, more positive active material per unit volume may be included and capacity per unit volume may be increased, thus increasing the entire energy density. Specifically, the positive active material including a compound having a spinel structure and represented by the above Chemical Formula 2 may have tap density of about 1.9 g/cc to about 2.5 g/cc.

The positive active material including a compound having a spinel structure and represented by the above Chemical Formula 2 may have a specific surface area of about 1.0 m²/g to about 10.0 m²/g. When the positive active material including a compound having a spinel structure and represented by the above Chemical Formula 2 has a specific surface area within the range, its side reaction with an electrolyte solution may be decreased. Specifically, the positive active material including a compound having a spinel structure and represented by the above Chemical Formula 2 has a specific surface area of about 4.0 m²/g to about 7.0 m²/g, and more specifically, a specific surface area of about 4.0 m²/g to about 5.0 m²/g.

The positive active material including a compound having a spinel structure and represented by the above Chemical Formula 2 may have pores. The pores may have an average diameter of about 1 nm to about 50 nm. When the pores included in the positive active material including a compound having a spinel structure and represented by the above Chemical Formula 2 have an average diameter within the range, the positive active material has a larger reaction area with an electrolyte solution and may easily intercalate and deintercalate lithium ions. Specifically, the pores included in the positive active material including a compound having a spinel structure and represented by the above Chemical Formula 2 have an average diameter of about 10 nm to about 20 nm.

The positive active material for a rechargeable lithium battery may be usefully applied to a positive electrode for an electrochemical cell such as a rechargeable lithium battery. The rechargeable lithium battery includes the positive electrode, a negative electrode including a negative active material, and an electrolyte.

The positive electrode includes a current collector and a positive active material layer disposed on the current collector.

The positive active material layer includes a binder and a conductive material.

The binder improves binding properties of the positive active material particles among themselves and to a current collector, and examples of the binder may be polyvinyl alcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material may be used to provide an electrode with conductivity, and any electrically conductive material can be used as a conductive agent unless it causes a chemical change. Examples of the conductive material may include one or more of natural graphite, artificial graphite, carbon black, acetylene black, ketjen black, a carbon fiber, a metal powder and a metal fiber such as copper, nickel, aluminum, silver, and the like, and a polyphenylene derivative.

The current collector may use Al, but is not limited thereto.

The negative electrode includes a current collector and a negative active material layer formed on the current collector, and the negative active material layer includes a negative active material.

The negative active material may include a material that reversibly intercalates/deintercalates lithium ions, a lithium metal, a lithium metal alloy, a material being capable of doping and dedoping lithium, or a transition metal oxide.

The material that reversibly intercalates/deintercalates lithium ions includes a carbon material, and may be any generally-used carbon-based negative active material in a lithium ion rechargeable battery. Examples of the carbon material include crystalline carbon, amorphous carbon, and a mixture thereof. The crystalline carbon may be non-shaped or sheet, flake, spherical, or fiber shaped natural graphite or artificial graphite. The amorphous carbon may be a soft carbon (carbon obtained by firing at a low temperature), a hard carbon (carbon obtained by firing at a high temperature), a mesophase pitch carbonized product, fired coke, and the like.

The lithium metal alloy include lithium and a metal of Na, K, Rb, Cs, Fr, Be, Mg, Ca, Sr, Si, Sb, Pb, In, Zn, Ba, Ra, Ge, Al, or Sn.

The material being capable of doping and dedoping lithium may include Si, SiOₓ (0<x<2), a Si-M alloy (wherein M is an alkali metal, an alkaline-earth metal, a Group 13 element, a Group 14 element, a transition element, a rare earth element, or a combination thereof, but is not Si), Sn, SnO₂, Sn-M (wherein M is an alkali metal, an alkaline-earth metal, a Group 13 element, a Group 14 element, a transition element, a rare earth element, or a combination thereof, but is not Sn), and the like, and at least one of these materials may be mixed SiO₂. The element M may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The transition metal oxide may include vanadium oxide, lithium vanadium oxide, and the like.

The negative active material layer includes a binder, and optionally a conductive material.

The binder improves properties of binding negative active material particles with one another and the negative active materials with a current collector, and examples of the binder may include polyvinyl alcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is used to provide an electrode with conductivity, and any electrically conductive material may be used as a conductive material unless it causes a chemical change. Examples of the conductive material include a carbon-based material such as natural graphite, artificial graphite, carbon black, acetylene black, ketjen black, a carbon fiber, and the like; a metal-based material of metal powder or metal fiber of copper, nickel, aluminum, silver, and the like; a conductive polymer such as a polyphenylene derivative; or a mixture thereof.

The current collector may be a copper foil, a nickel foil, a stainless steel foil, a titanium foil, a nickel foam, a copper foam, a polymer substrate coated with a conductive metal, or a combination thereof.

The positive electrode and the negative electrode may be manufactured by a method including mixing an active material, a binder, or the like in a solvent to prepare an active material composition, and coating the composition on a current collector. The electrode manufacturing method is well known, and thus is not described in detail in the present specification. The solvent includes N-methylpyrrolidone and the like, but is not limited thereto.

An electrolyte filled in the rechargeable lithium battery may be a non-aqueous electrolyte or well-known solid electrolyte, or an electrolyte including a lithium salt dissolved therein.

The non-aqueous electrolyte may include a solvent of a cyclic carbonate such as ethylene carbonate, diethylene carbonate, propylene carbonate, butylene carbonate, vinylene carbonate, and the like, linear carbonate such as dimethyl carbonate, ethylmethyl carbonate, diethyl carbonate, and the like, esters such as methyl acetate, ethyl acetate, propyl acetate, methyl propinonate, ethyl propinonate, γ-butyrolactone, and the like, ethers such as 1,2-dimethoxyethane, 1,2-diethoxyethane, tetrahydrofuran, 1,2-dioxane, 2-methyltetrahydrofuran, and the like, nitriles such as acetonitriles, and amides such as dimethylformamide, but is not limited thereto. These may be used singularly or in plural. Particularly, a mixed solvent of cyclic carbonate and linear carbonate may be used.

The electrolyte may be a gel polymer where an electrolyte solution is impregnated in a polymer electrolyte of polyethylene oxide, polyacrylonitrile, and the like, or an inorganic solid electrolyte of LiI, Li₃N, and the like, but is not limited thereto.

The lithium salt may be selected from the group consisting of LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlO₂, LiAlCl₄, LiCl, and LiI, but is not limited thereto.

The rechargeable lithium battery may further include a separator between a negative electrode and a positive electrode, as needed. The separator may include polyethylene, polypropylene, polyvinylidene fluoride or multi-layers thereof, mixed multi-layers thereof such as polyethylene/polypropylene double-layered separator, polyethylene/polypropylene/polyethylene triple-layered separator, polypropylene/polyethylene/polypropylene triple-layered separator, and the like.

Rechargeable lithium batteries may be classified as lithium ion batteries, lithium ion polymer batteries, and lithium polymer batteries according to the presence of a separator and the kind of electrolyte used therein. The rechargeable lithium batteries may have a variety of shapes and sizes, and include cylindrical, prismatic, coin, or pouch-type batteries, and may be thin film batteries or may be rather bulky in size. Structures and fabricating methods for lithium ion batteries pertaining to the present invention are well known in the art.

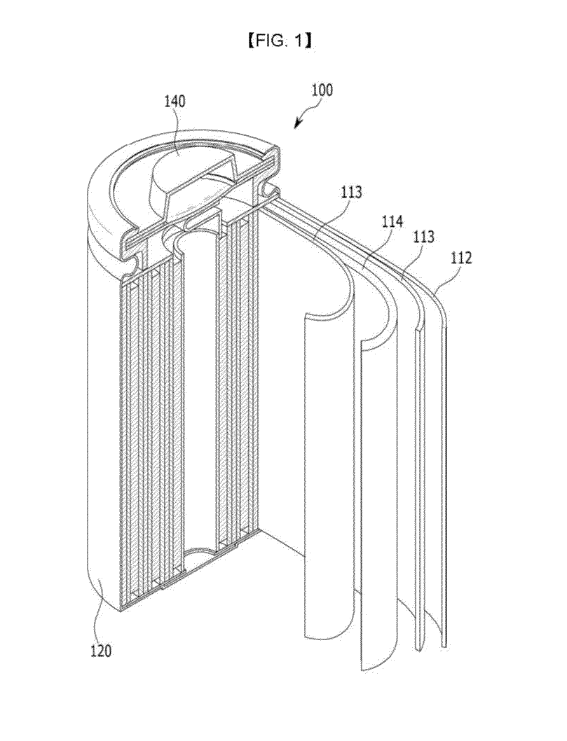

FIG. 1 is a schematic view of a rechargeable lithium battery according to one embodiment. As shown in FIG. 1, the rechargeable lithium battery 100 includes a negative electrode 112, a positive electrode 114, a separator 113 interposed between the negative electrode 112 and the positive electrode 114, an electrolyte (not shown) impregnated in the negative electrode 112, the positive electrode 114, and the separator 113, and a sealing member 140 sealing the battery case 120. The rechargeable lithium battery of the present embodiment may not be limited to specific shapes, and may have any shape such as cylindrical, coin-type, pouch-type, and the like if the rechargeable lithium battery is operative.

Hereinafter, examples and comparative examples are described. However, the following examples are specific examples of the present invention, and the present invention is not limited by the following examples.

### Example 1

### Preparation of Positive Active Material for Rechargeable Lithium Battery

4 L of distilled water was put in a co-precipitation reactor (with a capacity of 4 L and a spinning motor having output power of greater than or equal to 80 W), and agitated at a speed of 1000 rpm while maintaining it at 50° C.

A 2.0 M metal aqueous solution including a mixture of nickel sulfate, cobalt sulfate, and manganese sulfate mixed in a mole ratio of 2:1:7 was added to the reactor at a speed of 0.3 L/hour, and a 4.0 M ammonia solution was added thereto at a speed of 0.03 L/hour. Then, 20 parts by weight of sucrose as a carbon source was added to the reactor based on the total weight (100 parts by weight) of the nickel sulfate, cobalt sulfate, and manganese sulfate. In addition, the mixture was supplied with a 4.0 M sodium hydroxide solution to adjust the mixture to have pH of 10. Herein, an impeller was adjusted to have a speed of 1000 rpm. The flow of the resultant solution was adjusted such that the average residence time in the reactor was about 6 hours. When the reaction reached a steady state, a solution including a positive active material for a rechargeable lithium battery precursor was continuously obtained through an overflow pipe.

The solution including a positive active material precursor for a rechargeable lithium battery was filtered, washed with water, and dried in a 110° C. warm air drier for 15 hours. Accordingly, a positive active material precursor for a rechargeable lithium battery was prepared.

The positive active material precursor for a rechargeable lithium battery was mixed with lithium hydroxide (LiOH) in a mole ratio of 1.0:1.19. The mixture was primarily fired by increasing the temperature at a rate of 2° C./min and maintaining it at 280° C. for 5 hours, and secondarily fired at 900° C. for 10 hours, preparing a positive active material for a rechargeable lithium battery.

Accordingly, the positive active material for a rechargeable lithium battery included a compound having a layered structure represented by Li_{1.19}[Ni_{0.2}Co_{0.1}Mn_{0.7}]_{0.81}O₂.

### Example 2

### Preparation of Positive Active Material for Rechargeable Lithium Battery

4 L of distilled water was put in a co-precipitation reactor (with a 4 L capacity and output power of a spinning motor of greater than or equal to 80 W), and agitated at a speed of 1000 rpm while maintaining it at 50° C.

Next, a 2.0 M metal aqueous solution including manganese sulfate was added to the reactor at a speed of 0.3 L/hour, and then a 4.0 M ammonia solution was added thereto at a speed of 0.03 L/hour. Then, 20 parts by weight of sucrose as a carbon source was added thereto based on the total weight (100 parts by weight) of the manganese sulfate. In addition, the mixture was supplied with a sodium hydroxide solution with a concentration of 4.0 M to adjust the mixture to have pH of 10. Herein, an impeller in the reactor was adjusted to have a rate of 1000 rpm. The flow of the resultant solution was adjusted such that the average residence time in the reactor was about 6 hours. When the reaction reached a steady state, a solution including a positive active material precursor for a rechargeable lithium battery was continuously obtained through an overflow pipe.

The solution including a positive active material precursor for a rechargeable lithium battery was filtered, washed with water, and dried in a 110° C. warm air drier for 15 hours. Accordingly, a positive active material precursor for a rechargeable lithium battery was prepared.

The precursor positive active material for a rechargeable lithium battery was mixed with lithium hydroxide (LiOH) in a mole ratio of 2.0:1.0. The mixture was primarily fired by increasing the temperature at a rate of 2° C./min and maintaining it at 280° C. for 5 hours, and secondarily fired at 900° C. for 10 hours, preparing a positive active material for a rechargeable lithium battery.

Accordingly, the positive active material for a rechargeable lithium battery included a compound with a spinel structure represented by LiMn₂O₄.

### Example 3

### Fabrication of Rechargeable Lithium Battery Cell

The positive active material for a rechargeable lithium battery according to Example 1, Super-P as a conductive material, and polyvinylidene fluoride (PVdF) as a binder were mixed in a weight ratio 85:7.5:7.5, preparing a slurry. The slurry was uniformly coated on a 20 μm-thick aluminum foil and vacuum-dried at 120° C., fabricating a positive electrode.

The positive electrode was used with a lithium foil as a counter electrode, a 25 μm-thick porous polyethylene film (Celgard 2300, Celgard LLC) as a separator, and a liquid electrolyte solution prepared by mixing ethylene carbonate and diethyl carbonate in a volume ratio of 1:1 and dissolving LiPF₆ in a concentration of 1 M therein, fabricating a half coin cell.

### Example 4

### Fabrication of Rechargeable Lithium Battery Cell

A half coin cell was fabricated according to the same method as Example 3, except for using the positive active material according to Example 2.

### Comparative Example 1

### Preparation of Positive Active Material for Rechargeable Lithium Battery

A positive active material for a rechargeable lithium battery was prepared according to the same method as Example 1, except for using no carbon source.

The positive active material for a rechargeable lithium battery included a compound having a layered structure represented by Li_{1.19}[Ni_{0.2}Co_{0.1}Mn_{0.7}]_{0.81}O₂.

### Comparative Example 2

### Preparation of Positive Active Material for Rechargeable Lithium Battery

A positive active material for a rechargeable lithium battery was fabricated according to the same method as Example 2, except for using no carbon source.

The positive active material for a rechargeable lithium battery included a compound having a spinel structure represented by LiMn₂O₄.

### Comparative Example 3

### Fabrication of Rechargeable Lithium Battery Cell

A rechargeable lithium battery cell was fabricated according to the same method as Example 3, except for using the positive active material according to Comparative Example 1.

### Comparative Example 4

### Fabrication of Rechargeable Lithium Battery Cell

A rechargeable lithium battery cell was fabricated according to the same method as Example 3, except for using the positive active material according to Comparative Example 2.

### Experimental Example 1

### Scanning Electron Microscope (SEM) Measurements

The positive active materials for a rechargeable lithium battery according to Examples 1 and 2 and Comparative Examples 1 and 2 were respectively deposited on a carbon-coated copper grid, and a SEM photograph was taken of the cross-sections thereof. Herein, a field emission gun scanning electron microscope (FEG-SEM) (JSM-6390, JEOL Ltd.) was used.

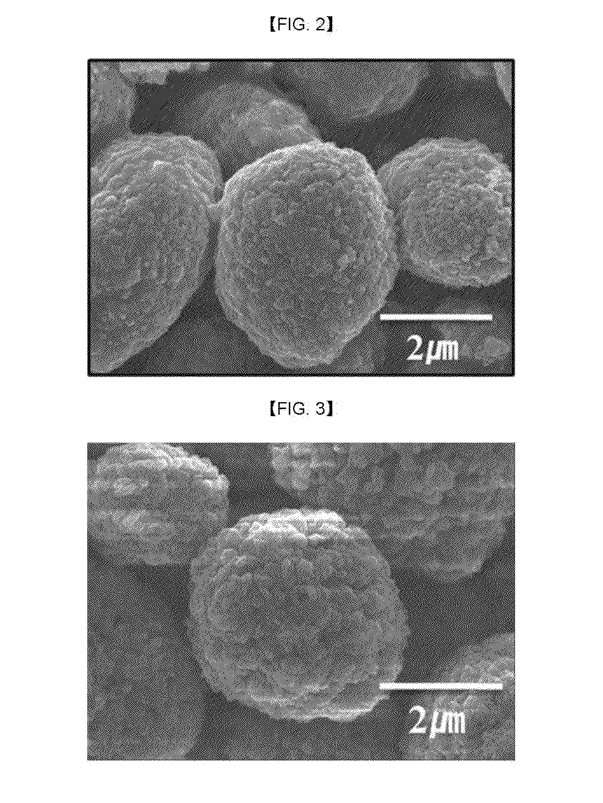

FIG. 2 shows a SEM photograph of the positive active material for a rechargeable lithium battery according to Example 1, and FIG. 3 shows a SEM photograph of the positive active material for a rechargeable lithium battery according to Comparative Example 1.

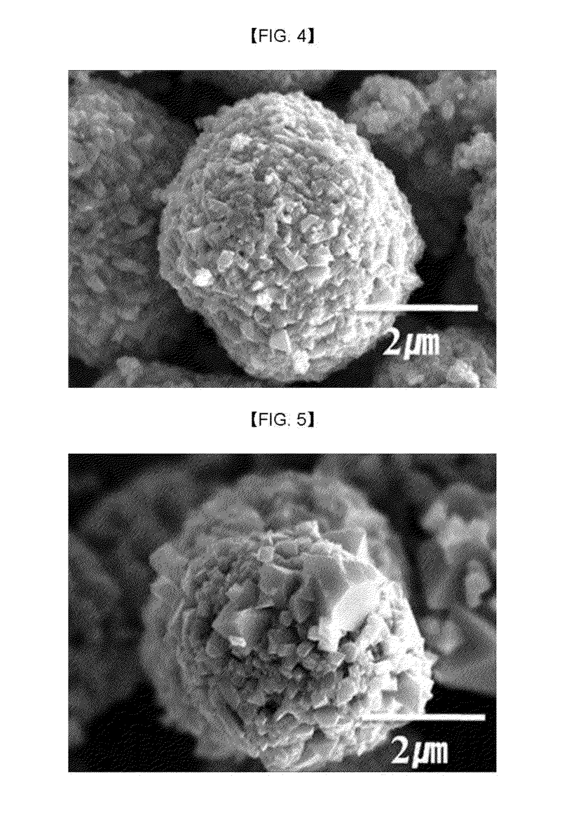

In addition, FIG. 4 shows a SEM photograph of the positive active material for a rechargeable lithium battery according to Example 2, and FIG. 5 shows a SEM photograph of the positive active material for a rechargeable lithium battery according to Comparative Example 2.

As shown in FIG. 2, the positive active material for a rechargeable lithium battery according to Example 1 included secondary particles formed by agglomerating a plurality of primary particles. The primary particles have an average particle diameter of about 100 nm.

As shown in FIG. 3, the positive active material for a rechargeable lithium battery according to Comparative Example 1 included secondary particles formed by agglomerating a plurality of primary particles. The primary particles have an average particle diameter of about 250 nm.

As shown in FIG. 4, the positive active material for a rechargeable lithium battery according to Example 2 included secondary particles formed by agglomerating a plurality of primary particles. The primary particles have an average particle diameter of about 200 nm.

As shown in FIG. 5, the positive active material for a rechargeable lithium battery according to Comparative Example 2 included secondary particles formed by agglomerating a plurality of primary particles. The primary particles have an average particle diameter of about 400 nm.

In other words, the positive active material according to Example 1 had smaller primary particles and thus a larger surface area than the active material according to Comparative Example 1. Accordingly, lithium might be easily intercalated and deintercalated in the positive active material of Example 1. In addition, the positive active material according to Example 2 had smaller primary particles and thus a larger surface area than the one according to Comparative Example 2. Accordingly, lithium might be easily intercalated and deintercalated in the positive active material of Example 2.

### Experimental Example 2

### Tap Density

500 drop strokes were respectively performed for the positive active materials according to Examples 1 and 2 and Comparative Examples 1 and 2 using a 10 mL graduated cylinder, and they were measured regarding tap density.

The positive active material according to Example 1 had a tap density of 2.1 g/cc, and the positive active material according to Comparative Example 1 had a tap density of 2.0 g/cc.

On the other hand, the positive active material according to Example 2 had a tap density of 2.2 g/cc, and the positive active material according to Comparative Example 2 had a tap density of 2.1 g/cc.

Accordingly, the positive active material according to Example 1 had a higher tap density than the one according to Comparative Example 1. In addition, the positive active material of Example 2 had a higher tap density than the one of Comparative Example 2.

### Experimental Example 3

### Specific Surface Area

The positive active materials according to Examples 1 and 2, Comparative Examples 1 and 2 were respectively measured regarding specific surface area using a BET analyzer (AS1-A4).

The positive active material according to Example 1 had a specific surface area of about 3.07 m²/g, and the positive active material according to Comparative Example 1 had a specific surface area of about 1.85 m²/g.

On the other hand, the positive active material according to Example 2 had a specific surface area of about 4.21 m²/g, and the positive active material according to Comparative Example 2 had a specific surface area of about 3.52 m²/g.

Accordingly, the positive active material according to Example 1 had a larger specific surface area than the one according to Comparative Example 1. In addition, the positive active material according to Example 2 had a larger specific surface area than the one according to Comparative Example 2.

### Experimental Example 4

### Average Pore Diameter

The positive active materials according to Examples 1 and 2 and Comparative Examples 1 and 2 were measured regarding average pore diameter using a BET analyzer.

The positive active material according to Example 1 had an average pore diameter of about 10 nm, and the positive active material according to Comparative Example 1 had an average pore diameter of about 2 nm.

On the other hand, the positive active material according to Example 2 had an average pore diameter of about 15 nm, and the one according to Comparative Example 2 had an average pore diameter of about 8 nm.

Accordingly, the positive active material according to Example 1 had bigger pores than the one according to Comparative Example 1. In addition, the positive active material according to Example 2 had bigger pores than the one according to Comparative Example 2.

### Experimental Example 5

### Initial Charge Capacity, Initial Discharge Capacity, and Initial Coulomb Efficiency

Half coin cells according to Example 3 and Comparative Example 3 were respectively charged and discharged once at 2.0 V to 4.6 V at 0.1C (20 mA/g) at 30° C. and measured regarding initial charge capacity, initial discharge capacity, and coulomb efficiency. In addition, half coin cells according to Example 4 and Comparative Example 4 were respectively charged and discharged once at 3.4 V to 4.3 V t 0.5C at 30° C. and measured regarding initial charge capacity, initial discharge capacity, and coulomb efficiency.

The half coin cell according to Example 3 had initial charge capacity of 297.1 mAh/g, initial discharge capacity of 248.8 mAh/g, and coulomb efficiency of 83.7%. The half coin cell according to Comparative Example 3 had initial charge capacity of 262.6 mAh/g, initial discharge capacity of 217.5 mAh/g, and coulomb efficiency of 82.8%.

On the other hand, the half coin cell according to Example 4 had initial charge capacity of 95.6 mAh/g, initial discharge capacity of 95.2 mAh/g, and coulomb efficiency of 99.6%. The half coin cell according to Comparative Example 4 had initial charge capacity of 89.1 mAh/g, initial discharge capacity of 88.7 mAh/g, and coulomb efficiency of 99.6%.

Accordingly, the positive active material according to Example 3 had excellent initial charge capacity, initial discharge capacity, and coulomb efficiency compared with the one according to Comparative Example 3. In addition, the positive active material according to Example 4 had excellent initial charge capacity and initial discharge capacity compared with the one according to Comparative Example 4. The positive active material according to Example 4 had coulomb efficiency corresponding to that of the one according to Comparative Example 4.

The reason that the positive active materials according to Examples 3 and 4 had excellent properties is that the positive active materials had small primary particles and thus easily intercalated and deintercalated lithium.

### Experimental Example 6

### Cycle-life Characteristic

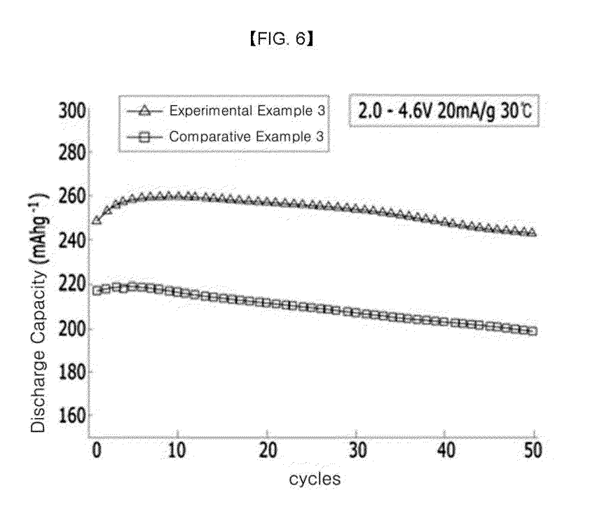

The half coin cells according to Example 3 and Comparative Example 3 were respectively charged and discharged at 2.0 V to 4.6 V at 0.1C (20 mA/g) and measured regarding discharge capacity change. The results are provided in FIG. 6.

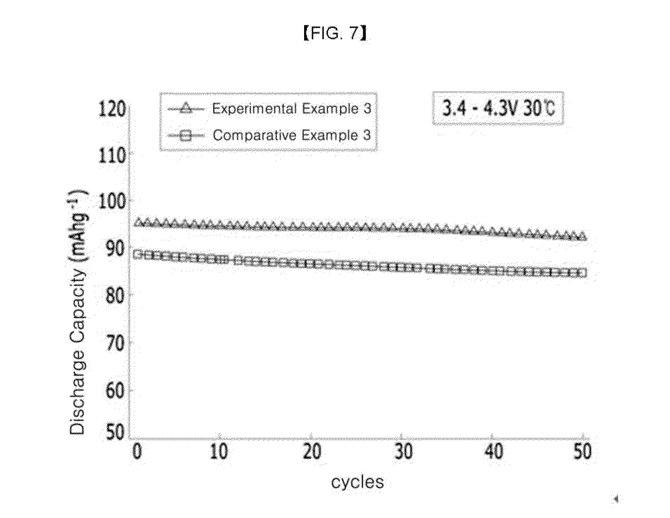

In addition, the half coin cells according to Example 4 and Comparative Example 4 were respectively charged and discharged at 3.4 V to 4.3 V at 0.5C and measured regarding discharge capacity change. The results are provided in FIG. 7.

After charge and discharge for 50 cycles, the cell according to Example 3 had capacity retention of 93.9%, and the cell according to Comparative Example 3 had capacity retention of 91.2%.

On the other hand, after charge and discharge for 50 cycles, the half coin cell according to Example 4 had capacity retention of 96.9%, and the half coin cell according to Comparative Example 4 had capacity retention of 95.5%.

Accordingly, the half coin cell according to Example 3 had an excellent cycle-life characteristic compared with the one according to Comparative Example 3. In addition, the half coin cell according to Example 4 had an excellent cycle-life characteristic compared with the one according to Comparative Example 4.

Accordingly, the positive active material for a rechargeable lithium battery according to the embodiment turned out to accomplish high capacity and effectively improve the cycle-life characteristic.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of preparing a positive active material for a rechargeable lithium battery, comprising:
forming a positive active material precursor for a rechargeable lithium battery by mixing at least one of a nickel source, a cobalt source, and a manganese source with a carbon source and a solvent; and
mixing the positive active material precursor for a rechargeable lithium battery and a lithium source followed by heat treatment.

2. The method of claim 1, wherein the nickel source comprises nickel sulfate, nickel nitrate, nickel acetate, nickel chloride, nickel phosphate, or a combination thereof.

3. The method of claim 1, wherein the cobalt source comprises cobalt sulfate, cobalt nitrate, cobalt acetate, cobalt chloride, cobalt phosphate, or a combination thereof.

4. The method of claim 1, wherein the manganese source comprises manganese sulfate, manganese nitrate, manganese acetate, manganese chloride, manganese phosphate, or a combination thereof.

5. The method of claim 1, wherein the carbon source comprises sucrose, glucose, polyvinyl alcohol (PVA), polyvinyl pyrrolidone (PVP), colloidal carbon, citric acid, tartaric acid, glycolic acid, polyacrylic acid, adipic acid, glycine, or a combination thereof.

6. The method of claim 1, wherein the solvent comprises water, ethanol, methanol, or a combination thereof.

7. The method of claim 1, wherein the positive active material precursor is formed by mixing the nickel source in an amount of 0 wt % to 75 wt %, the cobalt source in an amount of 0 wt % to 40 wt %, the manganese source in an amount of 0 wt % to 95 wt %, the carbon source in an amount of 2 wt % to 40 wt %, and the solvent in a balance amount.

8. The method of claim 1, wherein the carbon source is comprised in an amount of 5 to 30 parts by weight based on 100 parts by weight of the total weight of the nickel source, the cobalt source, and the manganese source.

9. The method of claim 1, wherein the positive active material precursor is formed by further comprising a transition element source.

10. The method of claim 9, wherein the transition element source comprises a sulfate of a transition element, a nitrate of a transition element, an acetate of a transition element, a chloride of a transition element, a phosphate of a transition element, or a combination thereof.

11. The method of claim 1, wherein the lithium source comprises lithium nitrate (LiNO₃), lithium acetate (CH₃COOLi), lithium carbonate (Li₂CO₃), lithium hydroxide (LiOH), or combination thereof.

12. The method of claim 1, wherein the active material precursor is mixed with the lithium source in a mole ratio of 1.0:0.95 to 1.0:1.25.

13. The method of claim 12, wherein the positive active material for a rechargeable lithium battery comprises a compound having a layered structure and represented by the following Chemical Formula 1:
Li₁₊ₓ[NiₐCo_{b}M_{c}Mn_{d}]₁₋ₓO_{2-y}F_{y} [Chemical Formula 1]
wherein, in the above Chemical Formula 1,
M is a transition element,
−0.05≦x≦0.25,
0≦y≦0.05,
0.2≦a≦0.9, 0≦b≦0.5, 0≦c≦0.05, 0.1≦d≦0.9, and a+b+c+d=1.

14. The method of claim 13, wherein the M comprises Ti, V, Cr, Fe, Cu, Zn, Y, Zr, Nb, Mo, W or a combination thereof.

15. The method of claim 1, wherein the active material precursor for a rechargeable lithium battery is mixed with the lithium source in a mole ratio of 1.0:0.4 to 1.0:0.6.

16. The method of claim 15, wherein the positive active material for a rechargeable lithium battery is a compound having a spinel structure and represented by the following Chemical Formula 2:
Li₁₊ₓ[NiₐCo_{b}M_{c}Mn_{d}]₂₋ₓO_{4-y}F_{y} [Chemical Formula 2]
wherein, in the above Chemical Formula 2,
M is a transition element,
0≦x≦0.1,
0≦y≦0.2,
0≦a≦0.3, 0≦b≦0.2, 0≦c≦0.15, 0≦d≦1.0, and a+b+c+d=1.

17. The method of claim 16, wherein the M comprises Ti, V, Cr, Fe, Cu, Zn, Y, Zr, Nb, Mo, W, or a combination thereof.

18. The method of claim 1, wherein the heat treatment is performed through primary firing at a temperature ranging from 250° C. to 650° C. and then secondary firing at a temperature ranging from 700° C. to 1000° C.

19. A positive active material for a rechargeable lithium battery prepared according to claim 1.

20. The positive active material of claim 19, which comprises a compound having a layered structure and represented by the following Chemical Formula 1:
Li₁₊ₓ[NiₐCo_{b}M_{c}Mn_{d}]₁₋ₓO_{2-y}F_{y} [Chemical Formula 1]
wherein, in the above Chemical Formula 1,
M is a transition element,
−0.05≦x≦0.25,
0≦y≦0.05,
0.2≦a≦0.9, 0≦b≦0.5, 0≦c≦0.05, 0.1≦d≦0.9, and a+b+c+d=1.

21. The positive active material of claim 20, wherein the positive active material comprises secondary particles formed by agglomerating a plurality of primary particles.

22. The positive active material claim 20, wherein the primary particles have an average particle diameter ranging from 1 nm to 500 nm.

23. The positive active material of claim 20, wherein the positive active material has tap density ranging from 1.5 g/cc to 3.0 g/cc.

24. The positive active material of claim 20, wherein the positive active material has a specific surface area of 1.0 m²/g to 10.0 m²/g.

25. The positive active material of claim 20, wherein the positive active material has pores having an average diameter of 1 nm to 50 nm.

26. The positive active material of claim 19, wherein the positive active material comprises a compound having a spinel structure and represented by the following Chemical Formula 2:
Li₁₊ₓ[NiₐCo_{b}M_{c}Mn_{d}]₂₋ₓO_{4-y}F_{y} [Chemical Formula 2]
wherein, in the above Chemical Formula 2,
M is a transition element,
0≦x≦0.1,
0≦y≦0.2,
0≦a≦0.3, 0≦b≦0.2, 0≦c≦0.15, 0≦d≦1.0, and a+b+c+d=1.

27. The positive active material of claim 26, wherein the positive active material comprises secondary particles formed by agglomerating a plurality of primary particles.

28. The positive active material of claim 26, wherein the primary particles have an average particle diameter of 1 nm to 1000 nm.

29. The positive active material of claim 26, wherein the positive active material has tap density of 1.5 g/cc to 3.0 g/cc.

30. The positive active material of claim 26, wherein the positive active material has a specific surface area of 1.0 m²/g to 10.0 m²/g.

31. The positive active material of claim 26, wherein the positive active material has pores having an average diameter of 1 nm to 50 nm.

32. A rechargeable lithium battery, comprising:
a positive electrode including a positive active material;
a negative electrode including a negative active material; and
an electrolyte,
wherein the positive active material is the positive active material for a rechargeable lithium battery according to claim 19.
